(19) United States
(12) Patent Application Publication
(10) Pub. No.: US 2008/0102294 A1
(43) Pub. Date: May 1, 2008

(54) Electrically conductive paste and method of making the same

(75) Inventors: Masayuki Kitajima, Kawasaki (JP); Yutaka Noda, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki-shi (JP)

(21) Appl. No.: 11/790,136

(22) Filed: Apr. 24, 2007

(30) Foreign Application Priority Data
Oct. 25, 2006 (JP) 2006-289744

(51) Int. Cl. H01B 1/22; B32B 15/04; B44C 1/22; C23F 1/16

(52) U.S. Cl. 428/457; 216/90; 252/512; 252/514

(57) ABSTRACT

Metallic powder particles disperse in paste matrix made of resin material. The metallic powder particles each defines a dissolved surface layer having reacted with acid solution. The metallic powder particles having reacted with acid solution is allowed to have a high electrical conductivity. The electrically conductive paste containing the mentioned metallic powder particles is also allowed to exhibit a sufficiently high electrical conductivity. The electrically conductive paste can thus be used for establishment of a fine wiring pattern and establishment of a wiring pattern for a high speed signal, for example. Moreover, the electrically conductive paste can easily be applied to a resin sheet in a predetermined pattern based on silk-screen printing, for example. The electrically conductive paste can be employed in various applications.

### BACKGROUND OF THE INVENTION

1. Field of the Invention:

The present invention relates to an electrically conductive paste useful for establishment of an electrically conductive pattern, for example.

2. Description of the Prior Art:

A membrane wiring board is often used for a keyboard, a touch panel and a signal cable, for example. The membrane wiring board includes a substrate made of resin and an electrically conductive pattern formed on the surface of the substrate. Electrically conductive paste is applied to the surface of the substrate so as to print the electrically conductive pattern, for example.

The electrically conductive paste is usually comprised of paste matrix made of resin material and silver powder particles dispersing in the paste matrix. The content of the silver powder particles are set at 60 weight % approximately in the total weight of the electrically conductive paste, for example.

Conventional electrically conductive paste has a high resistivity in the range between 20 and 40 μΩ/cm, approximately. As a result, the conventional electrically conductive paste cannot be used for establishment of a fine wiring pattern.

### SUMMARY OF THE INVENTION

It is accordingly an object of the present invention to provide electrically conductive paste capable of having a higher electrical conductivity. It is an object of the present invention to provide a method of making such electrically conductive paste.

According to a first aspect of the present invention, there is provided electrically conductive paste comprising: paste matrix made of resin material; and metallic powder particles dispersing in the paste matrix, the metallic powder particles each defining a dissolved surface layer having reacted with acid solution.

According to observation of the inventors, it was confirmed that the metallic powder particles having reacted with acid solution is allowed to have a high electrical conductivity. Accordingly, the electrically conductive paste containing the mentioned metallic powder particles is also allowed to exhibit a sufficiently high electrical conductivity. The electrically conductive paste can thus be used for establishment of a fine wiring pattern and establishment of a wiring pattern for a high speed signal, for example. Moreover, the electrically conductive paste can easily be applied to a resin sheet in a predetermined pattern based on silk-screen printing, for example. The electrically conductive paste can be employed in various applications.

The metallic powder particles may be made from silver. In this case, the acid solution may include nitric acid solution. Alternatively, the metallic powder particles may be made from at least either of copper or aluminum. In this case, the acid solution may include at least either of hydrochloric acid solution or sulfuric acid solution. The resin material may include at least either of thermosetting resin material or thermoplastic resin material.

According to a second aspect of the present invention, there is provided a method of making electrically conductive paste, comprising: immersing metallic powder particles into acid solution so as to form etched metallic powder particles having etched surfaces; and mixing the etched metallic powder particles with paste matrix made of resin material. This method contributes to production of electrically conductive paste having a sufficiently high electrical conductivity.

The method may allow employment of the metallic powder particles made from silver. In this case, the acid solution may include nitric acid solution. Alternatively, the metallic powder particles may be made from at least either of copper or aluminum. In this case, the acid solution may include at least either of hydrochloric acid solution or sulfuric acid solution. The resin material may include at least either of thermosetting resin material or thermoplastic resin material.

The method may allow addition of surfactant to the acid solution. The surfactant serves to prevent aggregation of the metallic powder particles in the paste matrix. Rust inhibitor may likewise be added to the acid solution. The rust inhibitor serves to prevent the metallic powder particles from getting rusted.

According to a third aspect of the present invention, there is provided metallic powder comprising metallic powder particles each defining a dissolved surface layer having reacted with acid solution. The metallic powder greatly contributes to realization of the aforementioned electrically conductive paste A specific method may be provided to make the metallic powder. The method may comprise immersing metallic powder particles into acid solution so as to form etched metallic powder particles having etched surfaces.

According to a fourth aspect of the present invention, there is provided a wiring board comprising: a substrate; and an electrically conductive pattern formed on the surface of the substrate, the electrically conductive pattern being made of electrically conductive paste including metallic powder particles dispersing in paste matrix made of resin material, the metallic powder particles each defining a dissolved surface layer having reacted with acid solution. As described above, the electrically conductive pattern made of the aforementioned electrically conductive paste is likewise allowed to have a relatively high electrical conductivity.

A specific method may be provided to make the wiring board. The specific method may comprise: applying electrically conductive paste on the surface of a substrate based on printing, the electrically conductive paste including metallic powder particles dispersing in paste matrix made of resin material, the metallic powder particles each defining a dissolved surface layer having reacted with acid solution; and hardening the paste matrix in the electrically conductive paste.

According to a fifth aspect of the present invention, there is provided a board unit comprising: a substrate; an electrically conductive pattern formed on the surface of the substrate, the electrically conductive pattern being made of electrically conductive paste including metallic powder particles dispersing in paste matrix made of resin material, the metallic powder particles each defining a dissolved surface layer having reacted with acid solution; and a component located on the surface of the substrate, the component being related to the electrically conductive pattern.

According to a sixth aspect of the present invention, there is provided an electronic apparatus comprising: an enclosure; a substrate enclosed in the enclosure; and an electrically conductive pattern formed on the surface of the substrate, the electrically conductive pattern being made of electrically conductive paste including metallic powder particles dispersing in paste matrix made of resin material, the metallic powder particles each defining a dissolved surface layer having reacted with acid solution.

A specific method may be provided to make the electronic apparatus. The specific method may comprise locating a wiring board in an enclosure, the wiring board including an electrically conductive pattern being made of electrically conductive paste including metallic powder particles dispersing in paste matrix made of resin material, the metallic powder particles each defining a dissolved surface layer having reacted with acid solution.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a perspective view schematically illustrating the structure of a notebook personal computer as a specific example of an electronic apparatus according to the present invention;

FIG. 2 is an enlarged partial sectional view schematically illustrating the structure of a keyboard; and

FIG. 3 is an enlarged partial sectional view schematically illustrating the composition of electrically conductive paste.

### DESCRIPTION OF THE PREFERRED EMBODIMENTS

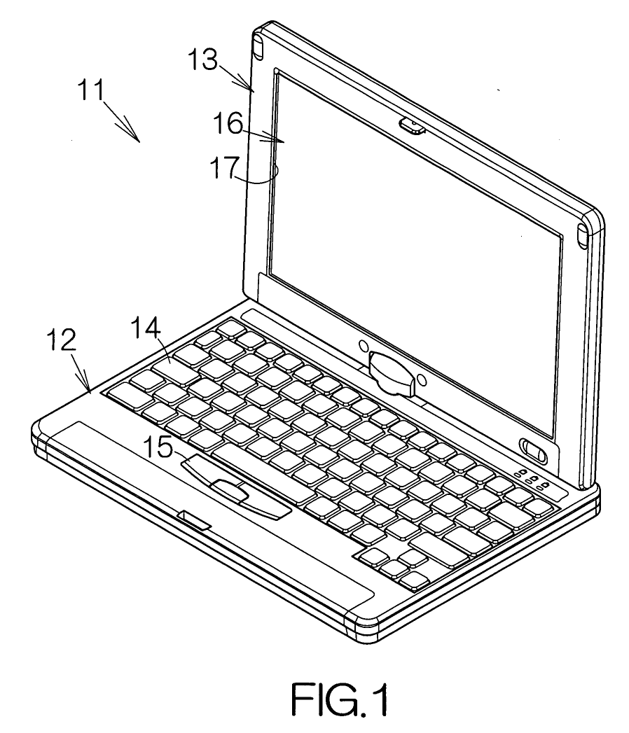

FIG. 1 schematically illustrates a notebook personal computer 11 as a specific example of an electronic apparatus according to the present invention. The notebook personal computer 11 includes a thin main enclosure 12. A display enclosure 13 is coupled to the main enclosure 12 for relative swinging movement. Input devices such as a board unit serving as a keyboard 14, a pointing device 15, and the like, are mounted on the front surface of the main enclosure 12. A user is allowed to input instructions and data through the keyboard 14 and the pointing device 15.

A liquid crystal display (LCD) panel module 16 is enclosed in the display enclosure 13, for example. The LCD panel module 16 defines a screen exposed in a window 17 defined in the display enclosure 13. Texts and/or graphics are allowed to appear on the screen. The texts and/or graphics help the user manage the operation of the notebook personal computer 11. The swinging movement of the display enclosure 13 on the main enclosure 12 realizes superposition of the display enclosure 13 on the main enclosure 12.

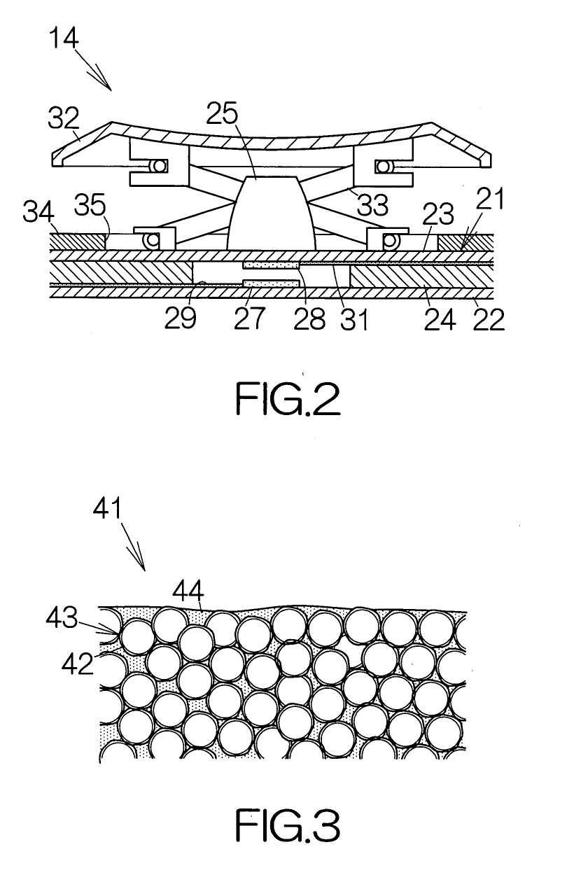

As shown in FIG. 2, the keyboard 14 includes a wiring board, that is, a membrane switch 21. The membrane switch 21 includes a lower contact sheet 22 and an upper contact sheet 23 opposed to the lower contact sheet 22. A spacer sheet 24 is interposed between the lower and upper contact sheets 22, 23. Rubber domes 25 are arranged on the outward surface of the upper contact sheet 23. The lower and upper contact sheets 22, 23 and the spacer sheet 24 may be made of resin material such as polyethylene terephthalate (PET). The lower and upper contact sheets 22, 23 correspond to a substrate according to the present invention.

Contacts 27 are formed on the opposed surface of the lower contact sheet 22. Contacts 28 are formed on the opposed surface of the upper contact sheet 23. An electrically conductive pattern 29 is formed on the opposed surface of the lower contact sheet 22. The electrically conductive pattern 29 is connected to the contacts 27. An electrically conductive pattern 31 is likewise formed on the opposed surface of the upper contact sheet 23. The electrically conductive pattern 31 is connected to the contacts 28. The contacts 27, 28 and the electrically conductive patterns 29, 31 contain at least one metallic material selected from a group consisting of silver, copper and aluminum. A method of forming the contacts 27, 28 and the electrically conductive patterns 29, 31 will be described later in detail.

A key top 32 is located above the individual rubber dome 25. The key top 32 is attached to a frame 34. A pantograph type supporting member 33 is utilized to connect the key top 32 to the frame 34, for example. An opening 35 is defined in the frame 34 for receiving the rubber dome 25. The supporting member 33 allows the key top 32 to move in the direction perpendicular to the surface of the membrane switch 21. The perpendicular movement of the key top 32 causes the rubber dome 25 to elastically deform. The rubber dome 25 urges the upper contact sheet 23 toward the lower contact sheet 22. The contact 28 comes into contact with the contact 27. Electric connection is in this manner established between the contacts 27, 28. Reactive elastic force of the rubber dome 25 causes the key top 32 to return to the initial position. A predetermined signal is in this manner input to the notebook personal computer 11.

Next, a brief description will be made below on a method of forming the contacts 27 and the electrically conductive pattern 29 on the surface of the lower contact sheet 22, for example. First of all, a PET sheet is prepared. Electrically conductive paste is applied to the surface of the PET sheet in a predetermined pattern based on printing. The electrically conductive paste includes paste matrix made of resin material and metallic powder mixed with the paste matrix. The metallic powder particles of the metallic powder disperse in the paste matrix. The electrically conductive paste will be described later in detail.

A silk-screen process is employed to apply the electrically conductive paste, for example. The mesh size is set in a range between 180 mesh and 250 mesh for the silk screen, for example. The thickness of emulsion is set in a range between 10 μm and 20 μm approximately. After the electrically conductive paste has been applied to the PET sheet based on printing, the electrically conductive paste is subjected to a heating treatment. The PET sheet is placed in a hot-air oven for 30 minutes approximately. The temperature is set at 150 degrees Celsius approximately in the hot-air oven, for example. The paste matrix in the electrically conductive paste gets hardened. The contact 27 and the electrically conductive pattern 29 are in this manner formed on the surface of the lower contact sheet 22.

An infrared (IR) oven may be employed in place of the aforementioned hot-air oven for heating the electrically conductive paste. The temperature may be set at 150 degrees Celsius approximately in the IR oven, for example. The PET sheet may be placed in the IR oven for 10 minutes approximately, for example.

The contacts 28 and the electrically conductive pattern 31 are likewise formed on the surface of the upper contact sheet 23. The formed lower and upper contact sheets 22, 23 are adhered to the front and back surfaces of the spacer sheet 24, respectively. The membrane switch 21 is thus produced. The components such as the rubber domes 25, the frame 34, the supporting members 33 and the key tops 32 are arranged on the membrane switch 21. The keyboard 14 is thus produced. The keyboard 14 is then assembled into the main enclosure 12. The notebook personal computer 11 is in this manner produced.

Next, a brief description will be made on the composition of the electrically conductive paste. As shown in FIG. 3, the electrically conductive paste 41 contains metallic powder particles 43. The metallic powder particle defines a dissolved surface layer 42. The metallic powder particles 43 disperse in paste matrix 44 made of resin material. The metallic powder particles 43 are made from metallic material such as silver, copper or aluminum, for example. Acid solution is employed to form the dissolved surface layer 42 as described later in detail. The median diameter of the metallic powder particles 43 may be set equal to or smaller than 40 μm, for example. Thermosetting resin material such as polyester resin or thermoplastic resin material such as epoxy resin may be used as the paste matrix 44.

Next, a brief description will be made below on a method of making the electrically conductive paste 41. First of all, metallic powder and acid solution are prepared. The metallic powder is comprised of silver powder particles, for example. A product from Fukuda Metal Foil & Powder Co., Ltd., “Silcoat® AgC-209” may be employed for the silver powder, for example. The median diameter of the silver powder particles may be set in a range between 2 μm and 20 μm, for example. A mixed solution of nitric acid solution and isopropyl alcohol is employed as the acid solution, for example. The mixed solution contains 95 volume % of isopropyl alcohol and 5 volume % of the nitric acid solution. 100 g of the silver powder is immersed in 200 cc of the acid solution for 5 minutes, for example. The surfaces of the silver powder particles are thus subjected to etching process. The silver powder particles are in this manner allowed to have dissolved surface layer 42.

Surfactant may be added to the acid solution. The surfactant may include any of dimethyldiglycol, methylpropyleneglycol and methylethyldiglycol. The surfactant serves to prevent aggregation of the silver powder particles. Rust inhibitor may likewise be added to the acid solution. The rust inhibitor may include imidazole, benzimidazole, alkyl benzimidazole, benzotriazol and mercaptobenzothiazole, for example. The rust inhibitor serves to prevent the silver powder particles from getting rusted.

The acid solution containing the silver powder is poured on a filter cloth. Bemcot® gauze is employed as the filter cloth, for example. Isopropyl alcohol is also poured into the filter cloth. The isopropyl alcohol serves to wash the nitric acid solution away from the etched silver powder particles having been subjected to the etching process. The filter cloth along with the etched silver powder particles is thereafter placed in a heater. The temperature is set at 50 degrees Celsius approximately in the heater, for example. The heater serves to dry the etched silver powder particles. The filter cloth is then taken out from the heater. The mass of the silver powder is transferred from the filter cloth to a mortar, for example. The mass of the silver powder is then ground in the mortar. A jet atomizer may be employed to grind the silver powder.

The silver powder particles are then mixed with a paste matrix. Here, thermosetting resin may be employed as the paste matrix, for example. 20 weight % of polyester resin is added to the 80 weight % of the silver powder in the total weight of 100 weight % of the electrically conductive paste, for example. The silver powder particles are brought into contact with each other in the paste matrix. The electrically conductive paste is in this manner produced. The electrically conductive paste is then placed in a vacuum defoaming device. The vacuum defoaming device serves to defoam the electrically conductive paste.

According to observation of the inventors, it was confirmed that the metallic powder particles 43 having reacted with acid solution is allowed to have a high electrical conductivity. Accordingly, the electrically conductive paste 41 containing the metallic powder particles 43 is also allowed to exhibit a sufficiently high electrical conductivity. The electrically conductive paste 41 can thus be used for establishment of a fine wiring pattern and establishment of a wiring pattern for a high speed signal, for example. Moreover, the electrically conductive paste 41 can easily be applied to a resin sheet in a predetermined pattern based on silk-screen printing, for example. The electrically conductive paste 41 can be employed in various applications.

On the other hand, 60 weight % of silver powder is mixed with 40 weight % of paste matrix made of resin to provide 100 weight % of a conventional electrically conductive paste, for example. The conventional electrically conductive paste has high resistivity in the range between 20 μΩ/cm and 40 μΩ/cm approximately. If the content of the silver powder is increased to reduce the resistivity, the conventional electrically conductive paste is forced to have a high viscosity. Silk-screen printing thus cannot be employed to apply the conventional electrically conductive paste to a resin sheet in a predetermined pattern, for example. This results in less application of the electrically conductive paste.

Copper powder or aluminum powder may be employed to produce the electrically conductive paste 41 in place of the aforementioned silver powder. In this case, the acid solution may include at least either of hydrochloric acid solution or sulfuric acid solution in place of the nitric acid solution. Otherwise, the etched metallic powder particles may be mixed with the paste matrix along with the non-etched metallic powder particles to provide the electrically conductive paste 41. Such an electrically conductive paste 41 is likewise allowed to have a higher electrical conductivity in the same manner as described above. Moreover, the electrically conductive paste 41 can be employed in various applications.

What is claimed is:

1. Electrically conductive paste comprising:
paste matrix made of resin material; and
metallic powder particles dispersing in the paste matrix, the metallic powder particles each defining a dissolved surface layer having reacted with acid solution.

2. The electrically conductive paste according to claim 1, wherein the metallic powder particles are made from silver.

3. The electrically conductive paste according to claim 2, wherein the acid solution includes nitric acid solution.

4. The electrically conductive paste according to claim 1, wherein the metallic powder particles are made from at least either of copper or aluminum.

5. The electrically conductive paste according to claim 4, wherein the acid solution includes at least either of hydrochloric acid solution or sulfuric acid solution.

6. The electrically conductive paste according to claim 1, wherein the resin material includes at least either of thermosetting resin material or thermoplastic resin material.

7. A method of making electrically conductive paste, comprising:
immersing metallic powder particles into acid solution so as to form etched metallic powder particles having etched surfaces; and
mixing the etched metallic powder particles with paste matrix made of resin material.

8. The method according to claim 7, wherein the metallic powder particles are made from silver.

9. The method according to claim 8, wherein the acid solution includes nitric acid solution.

10. The method according to claim 7, wherein the metallic powder particles are made from at least either of copper or aluminum.

11. The method according to claim 10, wherein the acid solution includes at least either of hydrochloric acid solution or sulfuric acid solution.

12. The method according to claim 7, wherein the resin material includes at least either of thermosetting resin material or thermoplastic resin material.

13. The method according to claim 7, wherein surfactant is added to the acid solution.

14. The method according to claim 7, wherein rust inhibitor is added to the acid solution.

15. Metallic powder comprising metallic powder particles each defining a dissolved surface layer having reacted with acid solution.

16. A method of making metallic powder, comprising immersing metallic powder particles into acid solution so as to form etched metallic powder particles having etched surfaces.

17. A wiring board comprising:
a substrate; and
an electrically conductive pattern formed on a surface of the substrate, the electrically conductive pattern being made of electrically conductive paste including metallic powder particles dispersing in paste matrix made of resin material, the metallic powder particles each defining a dissolved surface layer having reacted with acid solution.

18. A method of making a wiring board, comprising:
applying electrically conductive paste on a surface of a substrate based on printing, the electrically conductive paste including metallic powder particles dispersing in paste matrix made of resin material, the metallic powder particles each defining a dissolved surface layer having reacted with acid solution; and
hardening the paste matrix in the electrically conductive paste.

19. A board unit comprising:
a substrate;
an electrically conductive pattern formed on a surface of the substrate, the electrically conductive pattern being made of electrically conductive paste including metallic powder particles dispersing in paste matrix made of resin material, the metallic powder particles each defining a dissolved surface layer having reacted with acid solution; and
a component located on the surface of the substrate, the component being related to the electrically conductive pattern.

20. An electronic apparatus comprising:
an enclosure;
a substrate enclosed in the enclosure; and
an electrically conductive pattern formed on a surface of the substrate, the electrically conductive pattern being made of electrically conductive paste including metallic powder particles dispersing in paste matrix made of resin material, the metallic powder particles each defining a dissolved surface layer having reacted with acid solution.

21. A method of making an electronic apparatus, comprising locating a wiring board in an enclosure, the wiring board including an electrically conductive pattern being made of electrically conductive paste including metallic powder particles dispersing in paste matrix made of resin material, the metallic powder particles each defining a dissolved surface layer having reacted with acid solution.
